(19) United States
(12) Patent Application Publication
(10) Pub. No.: US 2020/0200716 A1
(43) Pub. Date: Jun. 25, 2020

(54) SYSTEM AND METHOD FOR EXTRACTING CO2 FROM A MOBILE PHASE

(71) Applicant: Waters Technologies Corporation, Milford, MA (US)

(72) Inventors: Michael O. Fogwill, Uxbridge, MA (US); Sebastien Besner, Bolton, MA (US); Scott Kelley, Brookline, MA (US); Joseph Michienzi, Plainville, MA (US)

(73) Assignee: Waters Technologies Corporation, Milford, MA (US)

(21) Appl. No.: 16/718,848

(22) Filed: Dec. 18, 2019

Related U.S. Application Data
(60) Provisional application No. 62/782,579, filed on Dec. 20, 2018.

(51) Int. Cl. G01N 30/14; G01N 30/22; G01N 30/74

(52) U.S. Cl. CPC G01N 30/14; G01N 30/74; G01N 30/22

(57) ABSTRACT

The present disclosure relates to methodologies, systems, and devices for extracting CO₂ from a mobile phase within a chromatography or extraction system. A mobile phase pump can pump a CO₂-based mobile phase through a chromatography column, and a BPR can decompress the mobile phase downstream of the column. Decompressed CO₂ can be extracted from the mobile phase using a gas-liquid separator located downstream of the chromatography column. A detector located downstream of the gas-liquid separator can then analyze a substantially liquid mobile phase.

### CROSS-REFERENCE TO RELATED APPLICATIONS

This application claims the benefit of and priority to U.S. Provisional Patent Application No. 62/782,579 filed Dec. 20, 2018 titled “SYSTEM AND METHOD FOR EXTRACTING CO₂ FROM A MOBILE PHASE,” the entire contents of which is hereby incorporated by reference in its entirety.

### FIELD OF THE TECHNOLOGY

The present disclosure generally relates to pressurized fluid systems used in chromatography or extraction systems. In particular, the present disclosure relates to systems and methods for extracting gaseous or highly compressible components from a mobile phase.

### BACKGROUND

Chromatography involves the flowing of a mobile phase over a stationary phase to effect separation. To speed-up and enhance the efficiency of the separation, pressurized mobile phases are introduced. Carbon dioxide based chromatographic systems use CO₂ as a component of the mobile phase flow stream, and the CO₂ based mobile phase is delivered from pumps and carried through the separation column as a pressurized liquid. The CO₂ based mobile phase is used to carry components of the analytes in a sample through the chromatography column and to a detection system.

### SUMMARY

Performing optical detection within a chromatography or extraction system raises a number of challenges, especially when dealing with a highly compressible mobile phase, such as a CO₂-based mobile phase. Technology for avoiding pressure changes within an optical detector would be beneficial and highly desirable.

According to one aspect of the present technology, a method for extracting a gaseous component from a mobile phase is disclosed. The method includes pumping a compressible mobile phase through a column. The method also includes extracting a compressible portion of the mobile phase from the output of the column upstream of a detector using a separator. The method also includes directing the substantially liquid component of the mobile phase to the detector. In a non-limiting example, the detector is a low pressure liquid optical detector. In another non-limiting example, the compressible portion of the mobile phase is CO₂ and the separator is a gas-liquid separator. In another non-limiting example, the method also includes decompressing the mobile phase downstream of the column and upstream of the gas-liquid separator using a back pressure regulator. In another non-limiting example, the method also includes directing the extracted gaseous CO₂ to waste. In another non-limiting example, the method also includes preventing degassing of residual CO₂ downstream of the detector using a back pressure regulator.

According to another aspect of the present technology, a method for extracting CO₂ from a mobile phase is disclosed. The method includes pumping a CO₂-based mobile phase through a column. The method also includes introducing a makeup fluid downstream of the column and upstream of a detector using a makeup pump. The method also includes extracting CO₂ from the mobile phase upstream of the detector. The method also includes directing the substantially liquid component of the mobile phase to a detector. In a non-limiting example, the detector is a low pressure liquid optical detector. In another non-limiting example, the makeup pump is configured to pump a makeup fluid having a same composition as a mobile phase solvent exiting the column. In another non-limiting example, the method also includes decompressing the mobile phase downstream of the column and upstream of the gas-liquid separator using a back pressure regulator. In another non-limiting example, the method also includes controlling the introduction of the makeup fluid in order to maintain a constant liquid flow rate through the detector. In another non-limiting example, the method also includes controlling the introduction of the makeup fluid according to a flow gradient inverse to a modifier pump flow gradient. In another non-limiting example, the method also includes preventing degassing of residual CO₂ downstream of the detector using a low pressure back pressure regulator.

According to another aspect of the present technology, a system for extracting CO₂ from a mobile phase is disclosed. The system includes a mobile phase pump configured to pump a CO₂-based mobile phase through a column. The system also includes a pressure control device configured to decompress the mobile phase downstream of the column. The system also includes a gas-liquid separator located downstream of the column and configured to extract CO₂ from the mobile phase. The system also includes a detector located downstream of the gas-liquid separator and configured to analyze a substantially liquid portion of the mobile phase. In a non-limiting example, the system also includes a makeup pump configured to introduce a makeup fluid downstream of a column. In another non-limiting example, the makeup fluid has a same composition as a mobile phase solvent exiting the column. In another non-limiting example, the system also includes a computing device configured to control an operation of the makeup pump in order to maintain a constant fluid flow rate through the detector. In another non-limiting example, the system also includes a computing device configured to control an operation of the makeup pump in order to introduce the makeup fluid according to a flow gradient inverse to a modifier pump flow gradient. In another non-limiting example, the system also includes a back pressure regulator located downstream of the detector and configured to prevent degassing of residual CO₂. In another non-limiting example, the pressure control device is a back pressure regulator.

The above aspects of the technology provide numerous advantages. For example, since the mobile phase is no longer pressurized, detectors can be directly borrowed from liquid chromatography and employed without modification. According to traditional techniques, such LC detectors can often require modifications, such as high pressure flow cells, for use in a CO₂-based chromatography systems. Such detectors could include UV-Vis, PDA, fluorescence, refractive index, etc. An additional advantage to this system is a reduction in noise in the detector. Since, after removal of the compressible component, the mobile phase is nearly incompressible, pressure fluctuations no longer significantly contribute to baseline noise. Further, eddying within the optical path no longer results in large optical noise. Overall, this invention increases the signal and decreases the noise of optical detection when used with a CO₂-based mobile phase.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

One of ordinary skill in the art will understand that the drawings primarily are for illustrative purposes and are not intended to limit the scope of the inventive subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is an example block diagram of a prior art chromatography system that utilizes an optical detector.

FIG. 2 shows an example block diagram of a chromatography system including an optical detector and a gas-liquid separator, according to an embodiment of the present disclosure.

FIG. 3 a flowchart illustrating an exemplary method for extracting a gaseous component from a mobile phase, according to an exemplary embodiment.

FIG. 4 shows an example block diagram of a chromatography system including an optical detector, a gas-liquid separator, and a makeup pump, according to an embodiment of the present disclosure.

FIG. 5 is a flowchart illustrating an exemplary method for extracting CO₂ from a CO₂-based mobile phase, according to an exemplary embodiment.

FIG. 6 shows an example apparatus that can be used to perform example processes and computations, according to principles of the present disclosure.

The features and advantages of the present disclosure will become more apparent from the detailed description set forth below when taken in conjunction with the drawings.

### DETAILED DESCRIPTION

Following below are more detailed descriptions of various concepts related to, and embodiments of, methodologies, apparatus and systems for extracting a gaseous component, such as CO₂, from a mobile phase prior to detection within a chromatography or extraction system. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means includes but is not limited to, the term “including” means including but not limited to. The term “based on” means based at least in part on.

Optical detection involves passing light through a sample and measuring the amount of light absorbed by the sample. Example detectors include ultraviolet visible (UV-Vis) detectors and photodiode array (PDA) detectors. Each operate on Beer's law (Equation 1)

A=ε1C (1)

A is the dimensionless absorbance, ε is a molar absorptivity coefficient (L mol⁻¹ cm⁻¹), 1 is the light path (cm) length, and C is the concentration (mol L⁻¹) of the analyte. Absorbtivity is an analyte-dependent physical constant. Accordingly, to increase absorbance, the path length of light within the detector cell can be increased, or the concentration of the analyte can be increased. Path length is often limited to by mechanical or manufacturing constraints and/or optimal volumes dictated by chromatographic performance. Concentration, on the other hand, is governed by amount injected and mobile phase flow rate. The amount injected and the mobile phase flow rate have an inverse relationship, so it can be challenging to optimize these parameters to improve detector response. For example, large flow rates allow for large injection volumes (pre-column dilution to avoid mass and volume overload). Additional detectors that can be used may include refractive index detectors and fluorescence detectors, which rely on different principles.

Optical detection is a concentration-sensitive detection technique. Accordingly, the response of the detector can increase if the concentration of an analyte is increased within the mobile phase. When operating with supercritical fluid chromatography (SFC) or other forms of CO₂-based chromatography/extraction, one could conceivably leverage the compressible nature of the mobile phase to increase the concentration of the analyte in the mobile phase after the column and before the detector. In a non-limiting example of the present disclosure, the mobile phase is depressurized, the CO₂ is removed, and the analyte is concentrated into the liquid portion of the mobile phase in order to concentrate the analyte in a CO₂-based chromatography or extraction system. Such concentration can increase the response of an optical detector.

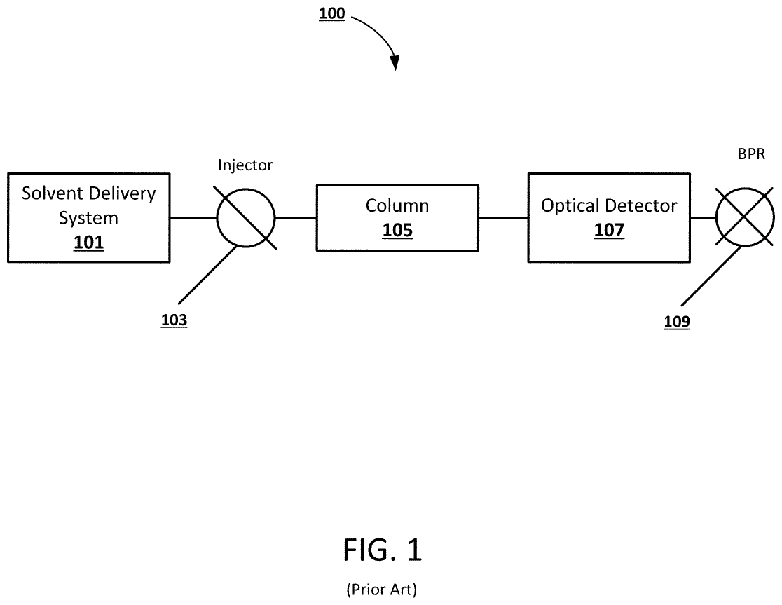

FIG. 1 illustrates an example block diagram of a prior art chromatography system 100 including an optical detector 107. The chromatography system 100 includes a solvent delivery system 101 and a sample injector 103 configured to introduce analytes and pump a mobile phase through a column 105. The column 105 temporarily separates the sample into individual analytes, which are individually detected by an optical detector 107. A back pressure regulator (BPR) 109 or some other pressure-controlling device can be disposed downstream of the optical detector 107 to maintain system pressure. For optical detection, the BPR 109 can maintain a minimum pressure to ensure liquid-like CO₂ and/or to guarantee miscibility between all mobile phase components. In some cases, the mobile phase can be composed of both CO₂ and a liquid modifier.

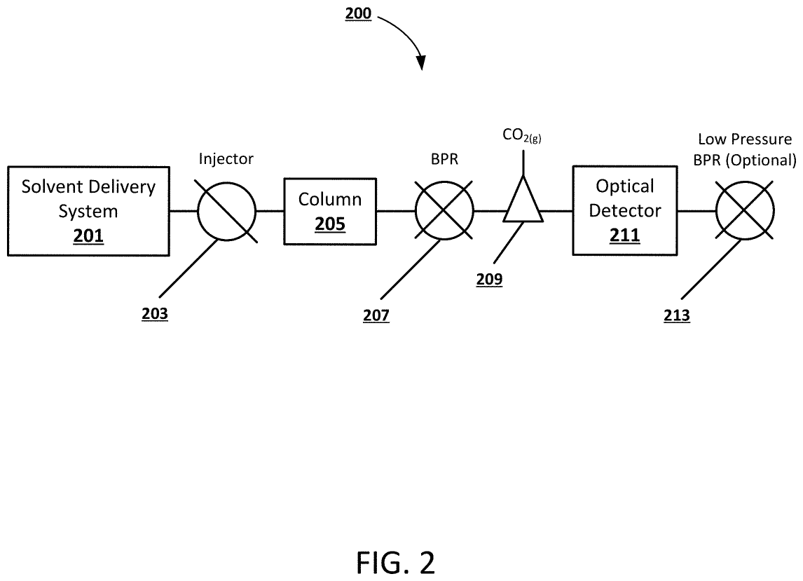

FIG. 2 shows an example block diagram of a chromatography system 200 including an optical detector 211 and a gas-liquid separator 209, according to an embodiment of the present disclosure. In a non-limiting example, the chromatography system 200 includes a solvent delivery system 201 and a sample injector 103 configured to introduce analytes and pump a mobile phase through a chromatography column 205. The mobile phase can be a high pressure fluid and include a compressible component, such as compressed CO₂. The column 205 can separate the sample into individual analytes which can be detected by an optical detector 211. In a non-limiting example, the mobile phase can be decompressed using a BPR 207 after separation, and the lower pressure CO₂ transitions to a gas and loses its miscibility with the liquid portion (modifier) of the mobile phase. After decompression, a gas-liquid separator 209 can direct the extracted gas (i.e. gaseous CO₂) to waste, while the liquid portion of the mobile phase including the analytes is directed to the optical detector 211. In a non-limiting example, the CO₂ may constitute a substantial or majority portion of the mobile phase and its removal can increase the concentration of the modifier. For example, if the mobile phase is 90:10 CO₂:methanol, the analyte would be concentrated by a factor of 10 after the gas-liquid separator 209. A secondary, low pressure (e.g. ˜100 PSI) BPR 213 can be placed downstream of the detector 211 to prevent any residual CO₂ from degassing in the optical cell, in some embodiments. This concept leverages the compressible nature of the mobile phase by intentionally decompressing prior to detection. In a non-limiting example embodiment, only a portion of the CO₂ could be removed to concentrate the analyte in the remaining mobile phase without eliminating the negative effects due to compressibility. In such an embodiment, a high pressure detector may be required.

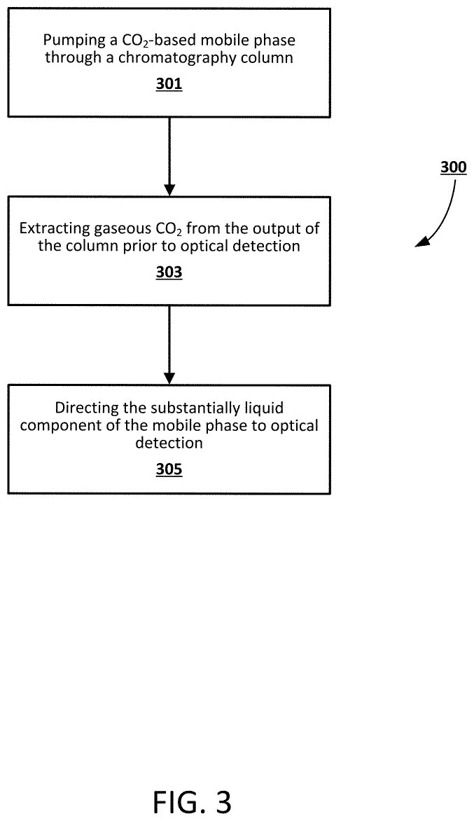

FIG. 3 is a flowchart illustrating an exemplary method 300 for extracting a gaseous component from a mobile phase within a chromatography or extraction system, according to an exemplary embodiment. It will be appreciated that the method can be programmatically performed, at least in part, by one or more computer-executable processes executing on, or in communication with, one or more servers or other computing devices such as those described further below. In step 301, a mobile phase including pressurized CO₂ is pumped through a column. After the CO₂-based mobile phase has passed through the column, the CO₂ can be extracted in step 303 using a gas-liquid separator prior to detection in order to achieve a substantially liquid mobile phase. In a non-limiting example, the mobile phase is decompressed downstream of the column and upstream of the gas-liquid separator using a BPR. The extracted gaseous CO₂ can be directed to waste, in some embodiments, while the liquid mobile phase can be directed in step 305 to an optical detector. Because the mobile phase has been depressurized and the CO₂ extracted, a low pressure liquid optical detector can be used, such as one with operating pressures between about 100-500 PSI in order to keep gases dissolved in the mobile phase. In a non-limiting embodiment, a low pressure BPR can be positioned downstream of the detector to prevent degassing of residual CO₂.

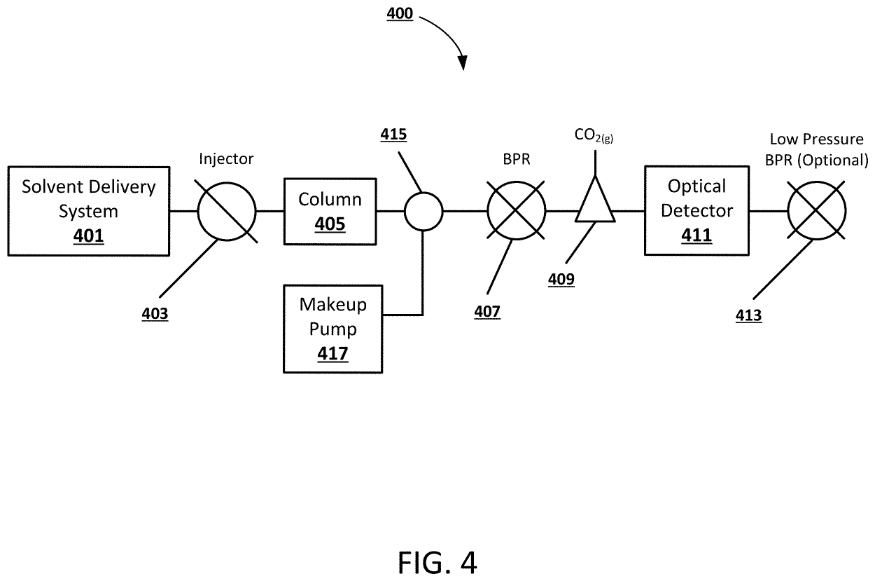

FIG. 4 shows an example block diagram of a chromatography system 400 including an optical detector 411, a gas-liquid separator 409, and a makeup pump 417, according to an embodiment of the present disclosure. In this particular embodiment, the makeup pump 417 is configured to introduce a makeup fluid downstream of the column 405 but upstream of the gas-liquid separator 409. In a non-limiting example, the chromatography system 400 includes a solvent delivery system 401 and a sample injector 403 configured to introduce analytes and pump a CO₂-based mobile phase through the column 405. As mentioned above in reference to FIG. 2, the column 405 can separate the sample into individual analytes which can be detected by an optical detector 411.

In a non-limiting example, the mobile phase can be decompressed using a BPR 407 after separation. As the lower pressure CO₂ transitions to a gas, it loses its miscibility with the liquid portion (modifier) of the mobile phase. In the example embodiment shown in FIG. 4, the makeup pump 417 introduces a makeup fluid downstream of the column and can help normalize the liquid flow through the optical detector 411 when a composition-programmed gradient is employed. Without this additional makeup fluid, early eluting (i.e. low modifier %) analytes would be more highly concentrated than late-eluting compounds. In a non-limiting example, the makeup pump could introduce a flow gradient that is inverse to the flow rate of a modifier pump in order to maintain a substantially constant liquid flow rate through the detector. In example embodiments, the makeup flow can be introduced before the BPR 407, at the BPR 407, post-BPR 407, in the gas-liquid separator 409, or after the gas-liquid separator 409. The gas-liquid separator 409 component may be a conventional momentum separator style gas-liquid separator, or it may be any device or feature which separates decompressed CO₂ from the liquid portion of the mobile phase. The gas-liquid separator 409 can direct the extracted CO₂ to waste, while the liquid portion of the mobile phase including the analytes, along with the makeup fluid, is directed to the optical detector 411. In a non-limiting example, a secondary, low pressure (e.g. ˜100 PSI) BPR 413 can be placed downstream of the detector 411 to prevent any residual CO₂ from degassing in the optical cell. An example low pressure BPR can include a spring-backed needle/seat or diaphragm BPR. Such a BPR may be set at a single pressure point and can operate at between 250 to 500 PSI to keep residual CO₂ dissolved in the liquid portion of the mobile phase. High pressure BPRs can be closed-loop active BPRs used to decouple flow and system pressures.

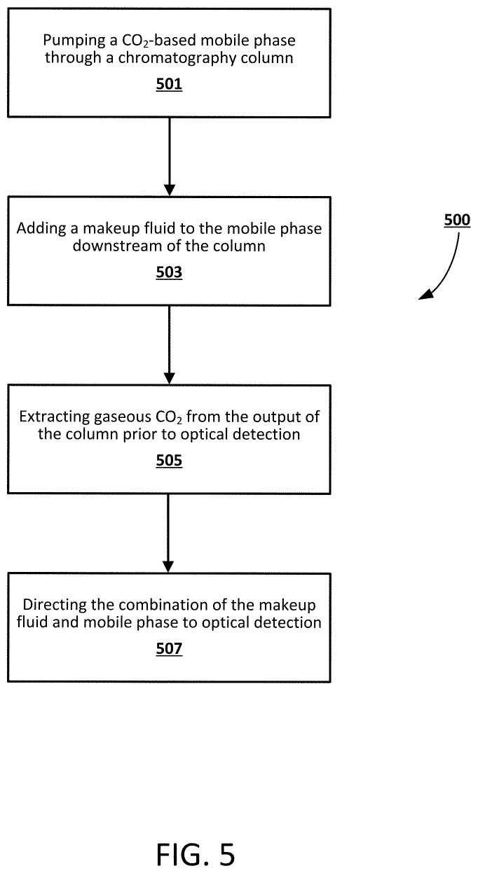

FIG. 5 is a flowchart illustrating an exemplary method 500 for extracting CO₂ from a CO₂-based mobile phase, according to an exemplary embodiment. It will be appreciated that the method can be programmatically performed, at least in part, by one or more computer-executable processes executing on, or in communication with, one or more servers or other computing devices such as those described further below. In step 501, a CO₂-based mobile phase is pumped through a column. In a non-limiting example, the CO₂-based mobile phase can be pumped using a solvent delivery system and an injector, as described above in reference to FIGS. 2 and 4.

In step 503, a makeup pump introduces a makeup fluid to the mobile phase downstream of the column and upstream of a detector. In a non-limiting example, the makeup pump can be controlled using a computer or other programmable processing device in order to introduce the makeup fluid at a particular flow rate downstream of the column. The makeup fluid can be introduced before a BPR, at the BPR, post-BPR, in a gas-liquid separator, or after the gas-liquid separator, according to various embodiments. In a non-limiting example, the makeup fluid has the same composition as the mobile phase solvent. In another example embodiment, the flow rate can be maintained with a reverse gradient or be used to ensure appropriate analyte transport when low or no liquid co-solvent is present, and the makeup fluid can be added post-column so as not to interfere with the separation performance of the system.

In step 505, CO₂ is extracted from the mobile phase upstream of the detector. In some embodiments, a BPR is configured to decompress the mobile phase downstream of the column and upstream of the gas-liquid separator. The gas-liquid separator component may be a conventional momentum separator style gas-liquid separator, or it may be any device or feature which separates decompressed CO₂ from the liquid portion of the mobile phase. The gas-liquid separator can also be configured direct the extracted CO₂ to waste in some embodiments.

In step 507, the substantially liquid mobile phase, which includes the introduced makeup fluid, is directed to an optical detector. Because the mobile phase has been depressurized and the gaseous CO₂ has been extracted in step 505, the detector can be a low pressure liquid optical detector. In a non-limiting example, the makeup pump can be controlled in order to introduce the makeup fluid at a rate configured to maintain a constant liquid flow rate through the detector. The makeup pump can also be controlled to introduce the makeup fluid according to a flow gradient inverse to a modifier pump flow gradient. In some embodiments, a low pressure BPR can be used to prevent degassing of residual CO₂ downstream of the detector. That is, the low pressure BPR is set to control pressure upstream of itself at a high enough pressure to ensure that any residual CO₂ remains dissolved in the non-compressible component of the mobile phase. Because the goal is to maintain the gas dissolved in the mobile phase, on a few hundred PSI need be applied (e.g., between about 100-500 PSI).

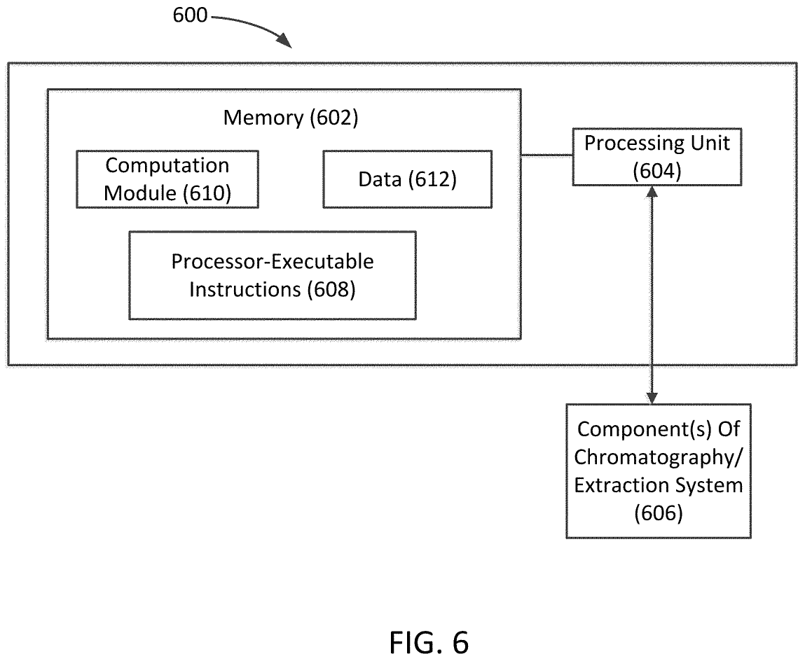

FIG. 6 shows a non-limiting example apparatus 600 that can be used to implement an example method for extracting gaseous components from a mobile phase within a chromatography or extraction system, according to the principles described herein. The apparatus 600 can include at least one memory 602 and at least one processing unit 604. The processing unit 604 can be communicatively coupled to the at least one memory 602 and also to at least one component of a chromatography or extraction system 606, such as the mobile phase pump, makeup pump, gas-liquid separator, or other components described herein.

The memory 602 can be configured to store processor-executable instructions 608 and a computation module 610. In an example method, as described in connection with FIGS. 3 and 5, the processing unit 604 can execute processor-executable instructions 608 stored in the memory 602 to control the operation of the gas-liquid separator and/or the makeup pump in order to increase or decrease the flow rate of the makeup fluid.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps can be replaced with a single element, component or step. Likewise, a single element, component or step can be replaced with a plurality of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methodologies. One of ordinary skill in the art will recognize that example methodologies can include more or fewer steps than those illustrated in the example flowcharts, and that the steps in the example flowcharts can be performed in a different order than the order shown in the illustrative flowcharts.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methodologies, if such features, systems, articles, materials, kits, and/or methodologies are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A method for extracting a gaseous component from a mobile phase, the method comprising:
pumping a compressible mobile phase through a column;
extracting a compressible portion of the mobile phase from an output of the column upstream of a detector using a separator; and
directing a substantially liquid component of the mobile phase to the detector.

2. The method of claim 1, wherein the detector is a low pressure liquid optical detector.

3. The method of claim 1, wherein the compressible portion of the mobile phase is CO₂ and the separator is a gas-liquid separator.

4. The method of claim 3, further comprising decompressing the mobile phase downstream of the column and upstream of the gas-liquid separator using a back pressure regulator.

5. The method of claim 3, further comprising directing the extracted gaseous CO₂ to waste.

6. The method of claim 3, further comprising preventing degassing of residual CO₂ downstream of the detector using a back pressure regulator.

7. A method for extracting CO₂ from a mobile phase, the method comprising:
pumping a CO₂-based mobile phase through a column;
introducing a makeup fluid downstream of the column and upstream of a detector using a makeup pump;
extracting CO₂ from the mobile phase upstream of the detector; and
directing a substantially liquid component of the mobile phase to a detector.

8. The method of claim 7, wherein the detector is a low pressure liquid optical detector.

9. The method of claim 7, wherein the makeup pump is configured to pump a makeup fluid having a same composition as a mobile phase solvent exiting the column.

10. The method of claim 7, further comprising decompressing the mobile phase downstream of the column and upstream of the gas-liquid separator using a back pressure regulator.

11. The method of claim 7, further comprising controlling the introduction of the makeup fluid in order to maintain a constant liquid flow rate through the detector.

12. The method of claim 7, further comprising controlling the introduction of the makeup fluid according to a flow gradient inverse to a modifier pump flow gradient.

13. The method of claim 7, further comprising preventing degassing of residual CO₂ downstream of the detector using a low pressure back pressure regulator.

14. A system for extracting CO₂ from a mobile phase, the system comprising:
a mobile phase pump configured to pump a CO₂-based mobile phase through a column;
a pressure control device configured to decompress the mobile phase downstream of the column;
a gas-liquid separator located downstream of the column and configured to extract CO₂ from the mobile phase; and
a detector located downstream of the gas-liquid separator and configured to analyze a substantially liquid portion of the mobile phase.

15. The system of claim 14, further comprising a makeup pump configured to introduce a makeup fluid downstream of the column.

16. The system of claim 15, wherein the makeup fluid has a same composition as a mobile phase solvent exiting the column.

17. The system of claim 15, further comprising a computing device configured to control an operation of the makeup pump in order to:
maintain a constant fluid flow rate through the detector.

18. The system of claim 15, further comprising a computing device configured to control an operation of the makeup pump in order to:
introduce the makeup fluid according to a flow gradient inverse to a modifier pump flow gradient.

19. The system of claim 15, further comprising a back pressure regulator located downstream of the detector and configured to prevent degassing of residual CO₂.

20. The system of claim 15, wherein the pressure control device is a back pressure regulator.
